(19) United States
(12) Patent Application Publication
(10) Pub. No.: US 2026/0220932 A1
(43) Pub. Date: Jul. 30, 2026

(54) VISUAL QUALITY ASSESSMENT SYSTEM

(71) Applicant: ClearObject Corporation, Fishers, IN (US)

(72) Inventors: Justin Dewitt, Boise, ID (US); Derek Bleyle, Cicero, IN (US)

(73) Assignee: ClearObject Corporation, FIshers, IN (US)

(21) Appl. No.: 19/460,634

(22) Filed: Jan. 27, 2026

Related U.S. Application Data
(60) Provisional application No. 63/750,798, filed on Jan. 29, 2025.

(51) Int. Cl. G06V 10/82; G06V 10/32; G06V 10/75; G06V 10/776; G06V 10/98

(52) U.S. Cl. CPC G06V 10/82; G06V 10/32; G06V 10/759; G06V 10/776; G06V 10/98

(57) ABSTRACT

A video camera captures several verified images and a test image of a product and sends the images to a server via a computing device over a network. The server matches the perspective the images to one another. The server crops the images to form an equal number of crop regions for each image with each corresponding crop region having the same size on each image. The server matches the perspective of each crop region, detects differences using an artificial intelligence component, and forms attention map sections. The server combines the attention map sections to form several attention maps. Then, the server merges the attention maps to form output for display on a display device.

### CROSS REFERENCE TO RELATED APPLICATION

This application claims the benefit under 35 U.S.C. §119(e) of co-pending U.S. Provisional Application No. 63/750,798 entitled “VISUAL QUALITY ASSESSMENT SYSTEM” filed January 29, 2025, which is incorporated herein by reference.

### BACKGROUND

The concepts of artificial intelligence (AI) and machine learning (ML) began to develop in the 1950s and grew, as computer technology became ubiquitous. Modern AI and ML technology because to appear in the early 2000s and surged since 2020, so that intelligent systems are playing an important role in our lives.

Digital transformations, driven by AI/ML technology are expected to revolutionize various fields, such as manufacturing, computer vision, smart agriculture, food processing, physics, drug discovery, social network analysis, security, etc.

One significant application relates to the automation of visual inspection systems for quality assessment. The aim of such systems is to ensure and improve the quality of products delivered to end-users. Visual content quality assessment can be divided into two categories: subjective assessment and objective assessment. The objective assessment methods quantify the quality of visual content by extracting features that can reflect defects. Since different contents have their own characteristics, and different defects exhibit different characteristics due to their different causes, the application of AI/ML technology can be used to automate such assessment systems to overcome these challenges.

In some cases the use of AI/ML systems can be limited due to impracticalities involved with collecting large amounts of training data due to the scarcity of the target occurrence (defect). There is a need for improved visual quality assessment systems that do not demand images of each target occurrence we wish to identify with the system, but rather a system that autonomously identifies occurrences which are out of the ordinary.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

In various implementations, a system includes a video camera, a computing device coupled to the video camera, a server coupled to the computing device over a network, and a display device coupled to the server over the network. The video camera captures a plurality of verified images and a test image depicting a product for inspection and sends the plurality of verified images and the test image to the server via the computing device. The server matches the perspective of each of the plurality of verified images and the test image to one another. The server crops the plurality of verified images and the test image to form an equal number of crop regions for each of the plurality of verified images and for the test image, so that each of the plurality of verified images has a crop region that is essentially the same size as a corresponding test image crop region. The server matches the perspective of each of the plurality of verified image crop regions with the perspective of the corresponding test image crop region. The server detects differences, with an artificial intelligence component, between each of the plurality of verified image crop regions and the corresponding test image crop region to form a plurality of attention map sections with each of the plurality of verified image crop regions having a corresponding attention map section. The server combines each one of the plurality of attention map sections to form a attention map for each of plurality of verified images. The server thresholds each attention map. The server merges each attention map with one another to form output for display on the display device.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1 is a schematic diagram of an operating environment for a visual quality assessment system in accordance with the subject disclosure.

FIG. 2 is a flow diagram illustrating the operation of the visual quality assessment system shown in FIG. 1.

FIG. 3 illustrates perspective match operations of three images of printed circuit boards.

FIG. 4 illustrates an image of one of the three printed circuit boards shown in FIG. 3 that has been subject to a perspective match operation.

FIG. 5 illustrates the identification of crop regions on a printed circuit board image.

FIG. 6 illustrates a perspective match of crop regions of printed circuit boards.

FIG. 7 illustrates the identification of differences in crop regions of printed circuit boards with little or no differences.

FIG. 8 illustrates the identification of differences in crop regions of printed circuit boards with substantial differences.

FIG. 9 illustrates a difference map formed from a plurality of difference map sections.

FIG. 10 illustrates the merger of difference maps.

FIG. 11 illustrates a merged difference map.

FIG. 12 illustrates the thresholding of the merged difference map shown in FIG. 11.

FIG. 13 illustrates a difference identified through the operation of the visual quality assessment system shown in FIG. 1.

FIG. 14 is an exemplary process in accordance with the disclosure.

FIG. 15 is a block diagram for an artificial intelligence/machine learning system.

FIG. 16 is an exemplary node within a cloud computing environment in accordance with the subject disclosure.

FIG. 17 is an exemplary computer system in accordance with the subject disclosure.

### DETAILED DESCRIPTION

The subject disclosure is directed to a visual quality assessment system and, more specifically, to methods and systems for utilizing artificial intelligence to compensating for differences in perspectives in images of products to identify potential defects therein.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

References to a “module”, “a software module”, and the like, indicate a software component or part of a program, an application, and/or an app that contains one or more routines. One or more independently modules can comprise a program, an application, and/or an app.

References to an “app”, an “application”, and a “software application” shall refer to a computer program or group of programs designed for end users. The terms shall encompass standalone applications, thin client applications, thick client applications, web-based applications, such as a browser, and other similar applications.

References to “artificial intelligence” and/or “AI” shall relate to artificial intelligence components and/or machine learning components of computer systems and/or computing devices. The artificial intelligence components can emulate human thought and perform tasks in a real-world environment, namely identifying patterns, making decisions, and improving operations through experience and data. The artificial intelligence components can use deep learning, neural networks, computer vision, and natural language processing. The artificial intelligence components utilize trained models that can be built by reviewing substantial volumes of documents, as well as other information and data.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding

elements throughout. The drawings and detailed description are not intended to limit the claimed subject matter to the particular form described. Rather, the intention is to cover all modifications, equivalents and alternatives falling within the spirit and scope of the claimed subject matter.

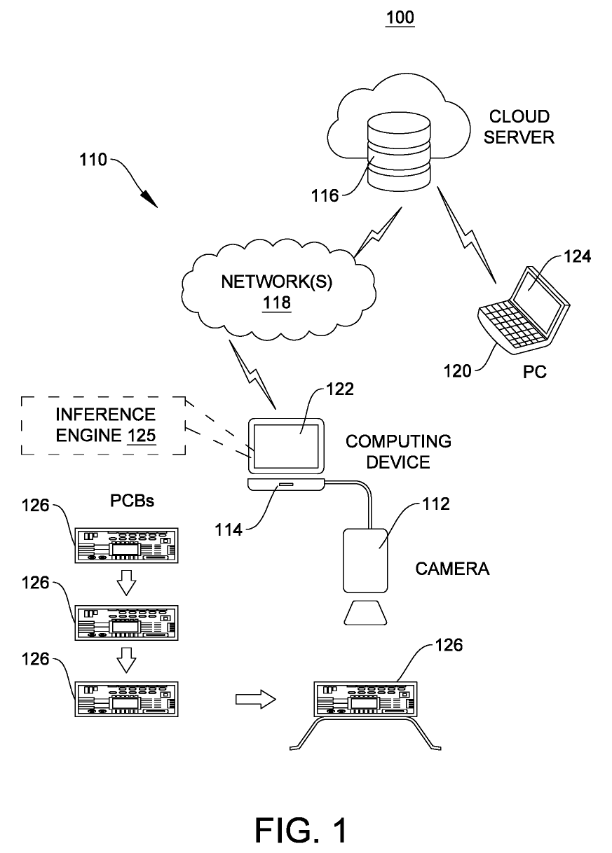

Referring to the drawings and, in particular, to FIG. 1, there is shown an operating environment, generally designated with the numeral 100, in which an artificial intelligence-based visual quality assessment system 110 operates. The system 110 includes a video camera 112, a computing device 114, and a server 116 connected to the computing device 114 over a network 118. The system 110, optionally, can one or more additional computing devices 120 connected over the network 118. The computing devices 114 and 120 and/or the server 116 can include one or more display devices 122-124 for showing output from the system 110. In this exemplary embodiment, the server 116 is a cloud server.

The system 110 utilizes the video camera 112 to obtain images of objects 126 that are products for quality assessment purposes. In this exemplary embodiment, the objects 126 are printed circuit boards (PCBs). However, the application of the system 110 is not limited to performing visual quality assessments of printed circuit boards.

The system 110 is configured to address a common problem in which different images of different objects 126 invariably have slightly different perspectives, which make it difficult to identify differences and/or defects between small structures on those o Indeed, all images, whether they contain a quality issue or not, are taken with slightly different perspectives, which make it difficult to identify structural similarities (or differences) between the images, especially when the structural features are on a small scale (or even on a micro-scale).

It should be understood that the system 110 is deployable onto multiple hardware platforms, inclusive of edge and cloud-based computing options. In this exemplary embodiment, system 110 utilizes graphics processing units (GPUs) to enable the real-time processing of video with AI.

Network 118 can be implemented by any type of network or combination of networks including, without limitation: a wide area network (WAN) such as the Internet, a local area network (LAN), a Peer-to-Peer (P2P) network, a telephone network, a private network, a public network, a packet network, a circuit-switched network, a wired network, and/or a wireless network. Computer systems and/or computing devices, such as the computing device 114, the computing device 120 and/or the server 110, can communicate

via network 118 using various communication protocols (e.g., Internet communication protocols, WAN communication protocols, LAN communications protocols, P2P protocols, telephony protocols, and/or other network communication protocols), various authentication protocols, and/or various data types (web-based data types, audio data types, video data types, image data types, messaging data types, signaling data types, and/or other data types).

It should be understood that the network 118 is not required in all embodiments of the invention. In this exemplary embodiment, the network 118 can be used to allow remote developers to collect training data, to upload system output for access by system developers and customers and/or to allow users to access, remotely, to perform various development-related tasks. Network access is not required to perform core computation tasks.

The computing device 114 and the computing device 120 can be any type of computing device, including a server, a smartphone, a handheld computer, a tablet, a PC, or any other computing device. In some embodiments, the computing device 114 can be an edge device.

An edge device can provide more intelligence and computing power with advanced services at the network edge. An inference engine can be used by the edge device to obtain inferences and build models faster than existing artificial intelligence-based visual inspection systems.

An edge device is any piece of hardware that controls data flow at the boundary between two networks. Edge devices fulfill a variety of roles, depending on what type of device they are, but they essentially serve as network entry -- or exit -- points. In particular, edge devices can be configured to implement machine learning techniques to improve their operation and/or the edge data they generate. In particular, an edge device can build or utilize a model from a training set of input observations, to make a data-driven prediction rather than following strictly static program instructions.

In this exemplary embodiment, the computing device 120 can be an edge device that includes an inference engine 125. The inference engine 125 can provide a complete platform for streamlining the development and onboarding of new vision system use cases.

The inference engine 125 has the ability to be highly configurable for a variety of use cases. The inference engine 125 can support multiple vision AI model types

(segmentation, classification, and object tracking). The inference engine 125 can support OPC UA protocol for and custom PLC integrations

The inference engine 125 can include integrations for live streaming video to the cloud for monitoring purposes with support for multiple messaging services. The inference engine 125 can utilize a well-defined schema for storing data in the cloud on the server 116.

In this exemplary embodiment, the interference engine 125 has the ability to be utilized for high throughput and low latency scenarios. The inference engine 125 utilizes a core pipeline that is highly optimized for parallel processing with GPUs and has been designed for real world, real-time artificial intelligence edge use cases. In some embodiments, the inference engine 125 can configure reduced video resolutions within the pipeline to enable higher throughput.

The inference engine 125 can enable post-processing calculations in real-time beyond what an artificial intelligence model provides. The inference engine 125 can enable users of the system to “instance detect” where objects are located and to perform additional calculations, such as size, distance between objects, or color intensity. The inference engine 125 enables vision systems to ensure sensitive information can be obfuscated before the information leaves the pipeline, such as the detection of blurring faces.

The inference engine 125 can provide the system 110 with out-of-the box connectivity that enables monitoring of both the use case of interest and the artificial intelligence vision system itself (MLOps). The inference engine 125 can produce, in near real-time, a video stream with overlaid inference results. These results can be streamed to the cloud on the server 116 from the inference engine 125 for remote monitoring purposes.

The inference engine 125 can support the highly structured logging of data with support of multiple messaging services, enabling a near real-time data feed for use by other services that may need data for notification or analytics purposes. These data feeds can be used for monitoring any drift in the results of the inference engine 125 or monitoring various aspects of the systems being monitored by the vision system.

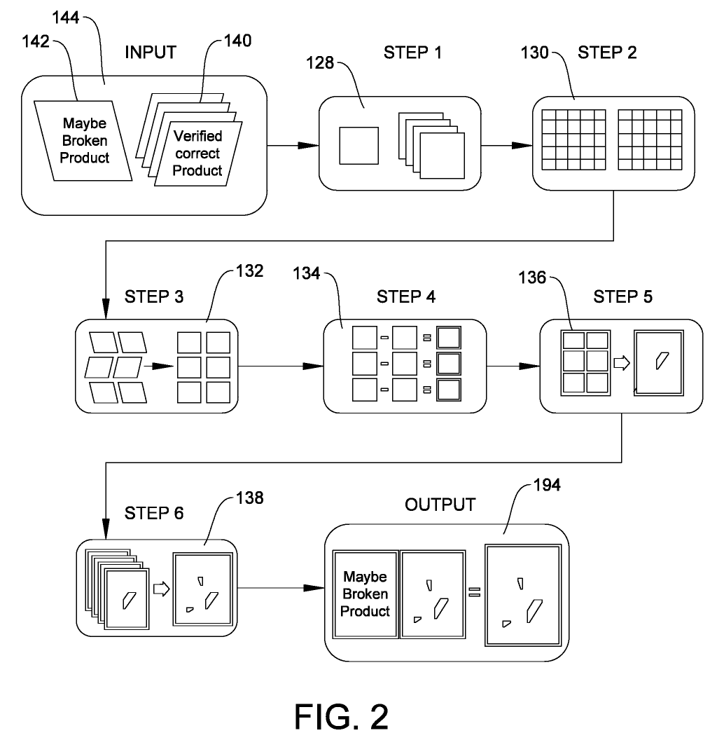

Referring now to FIGS. 2-13, the operation of the system 110 is shown, schematically, as a series of steps, 128-138 in which the system 110 performs a visual quality assessment of the objects 126 shown in FIG. 1. As shown in FIGS. 1-2, the video camera 112 obtains images of a various verified images 140 of working objects 126 and an image 142 of a potentially defective object 126. The images 140-142 are sent, as input

144, to the server 116 through the computing device 114 via the network 118 for processing.

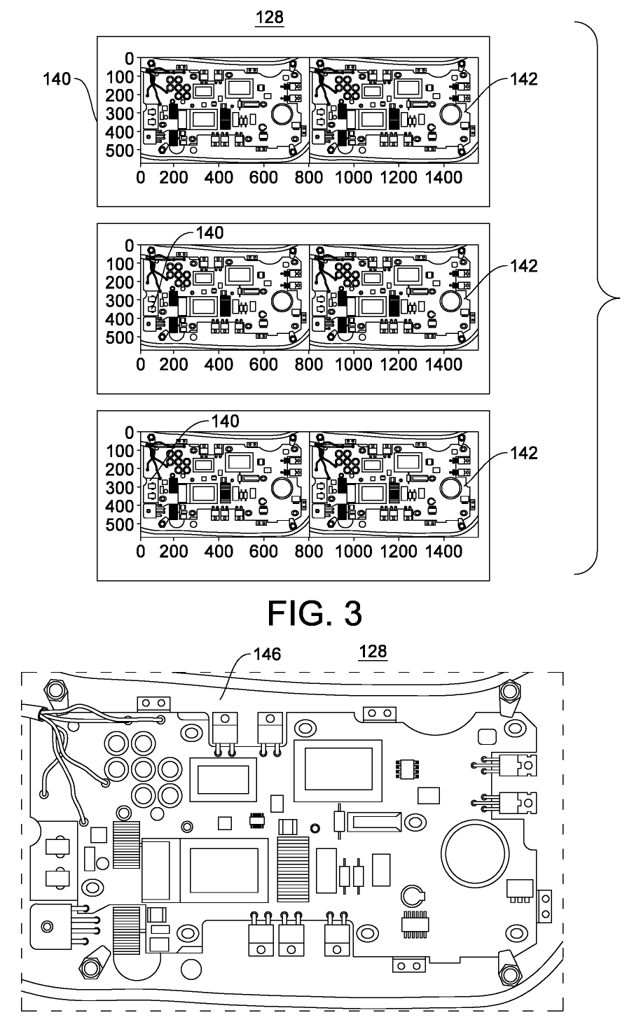

The first step 128 in the operation of the system 110 is illustrated in more detail in FIGS. 3-4. In this exemplary embodiment, the perspective of three verified images 140 are matched to the image 142, so that the structures and/or dimensions of the verified images 140 can be directly compared to the structures and/or dimensions of the image 142.

Once the perspectives of the images 140-142 have been matched, the images 140-142 can be overlayed over one another for comparison purposes to form the output 146 shown in FIG. 4.

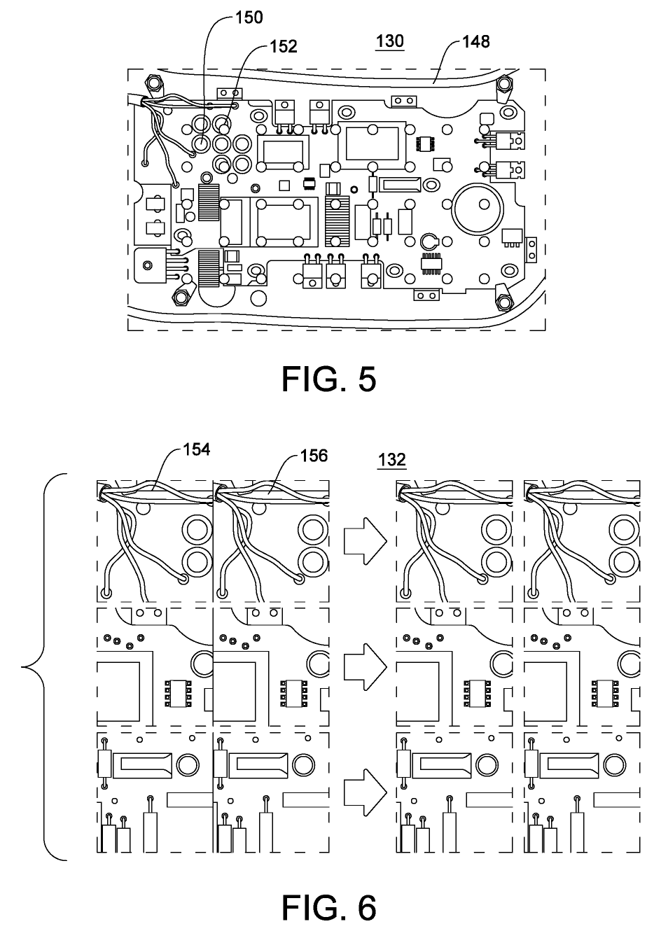

The second step 130 in the operation of the system 110 is illustrated in more detail in FIG. 5. In this exemplary embodiment, an image 148 of one of the objects 126, shown in FIG. 1, can be divided up into crop regions 150 as indicated by the dots 152 thereon.

The third step 132 in the operation of the system 110 is illustrated in more detail in FIG. 6. In this exemplary embodiment, the perspectives of crop regions 154 of standardized or verified images can be match to the perspective of the potentially defective image 156, so that the structural features and/or dimensions of each of the crop regions 154 can be compared to a corresponding crop region from a different image (not shown).

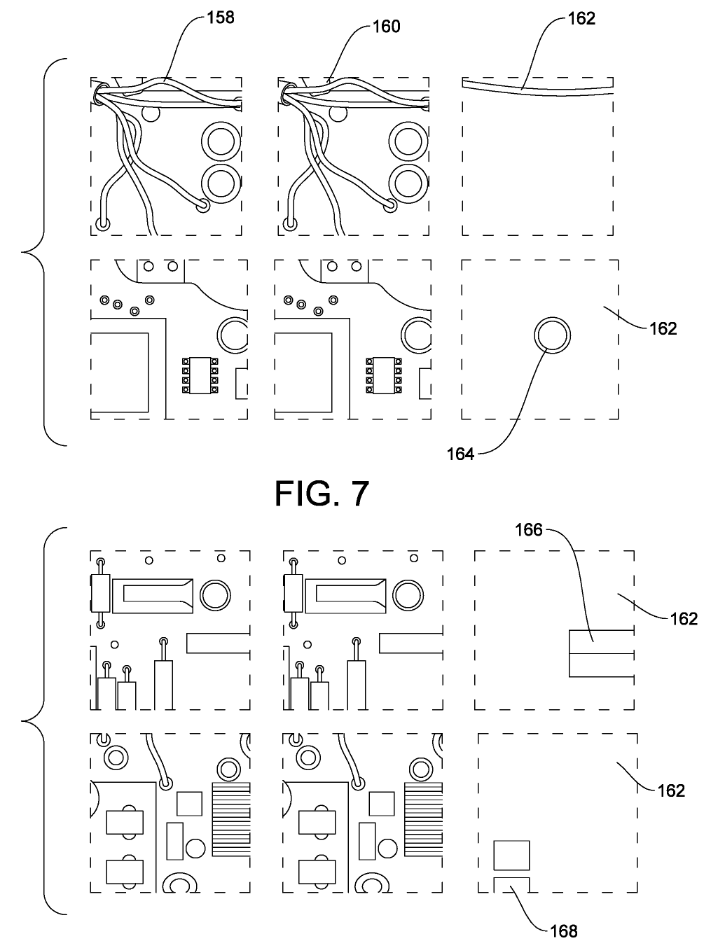

The fourth step 134 in the operation of the system 110 is illustrated in more detail in FIGS. 7-8. In this exemplary embodiment, a crop region 158 from one image, such as one of the verified images 140 shown in FIGS. 3-4, can be compared to a corresponding crop region 160 from the image 142 shown in FIGS. 3-4 to identify differences (and potential defects) therein. The differences can be identified using a trained AI or ML model.

The differences can be illustrated through overlays 162. The overlays 162 can contain no defects, smaller sections 164 indicative of smaller defects, or larger sections 166-168 indicative of larger defects. The larger defects are more noticeable.

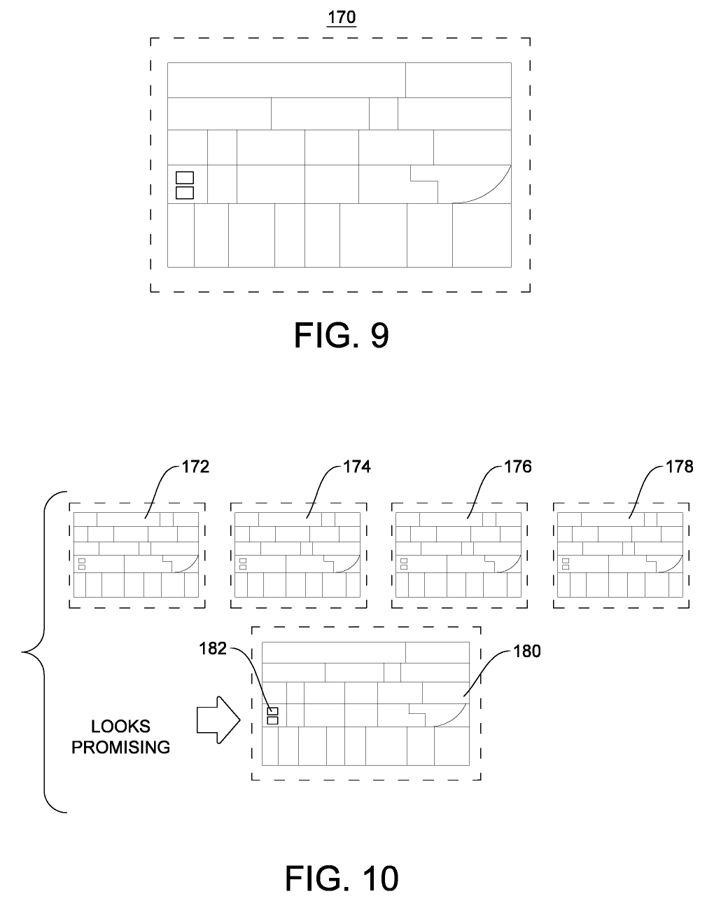

The fifth step 136 in the operation of the system 110 is illustrated in more detail in FIG. 9. In this exemplary embodiment, the overlays 162 shown in FIGS. 7-8 can be combined with one another to construct a combined difference map 170. The combined difference map 170 can be an attention map indicating areas or sections that may indicate defects within the objects 126 shown in FIG. 1.

The sixth step 138 in the operation of the system 110 is illustrated in more detail in FIG. 10. In this exemplary embodiment, four combined difference maps 172-178

that are based on standard or verified products can be merged to form a merged difference map 180 to eliminate noise and to indicate significant areas 182 of differences or deviations representing potentially defective products.

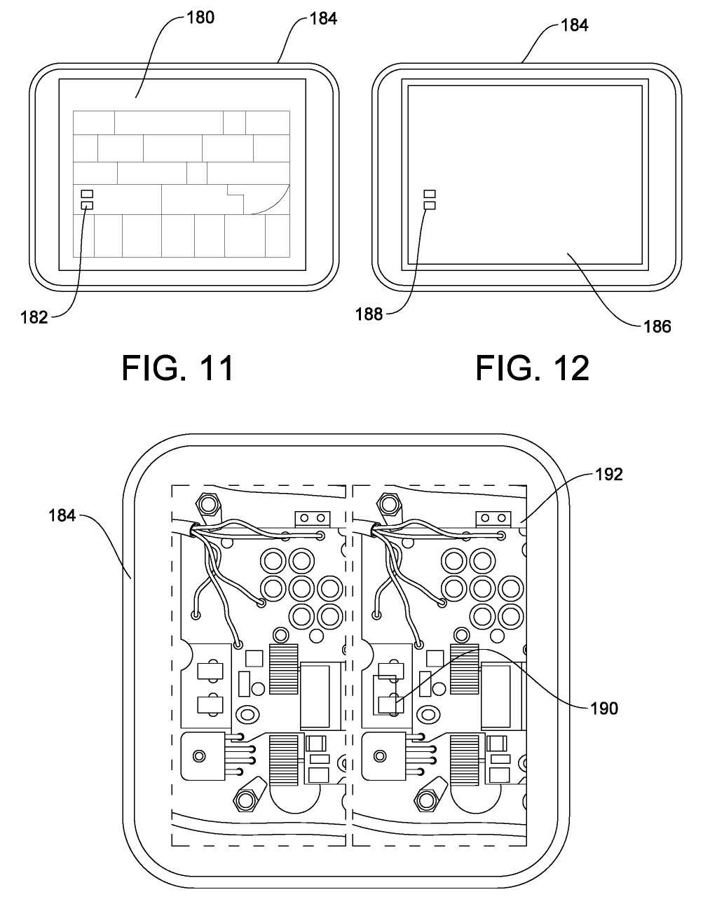

Referring to FIGS. 11-13, the merged difference map 180 can be displayed on a display device 184. The display device 184 can be one of the display devices 122-124 shown in FIG. 1. Then, the merged difference map 180 can be subjected to a thresholding operation to form a threshold map 186.

The threshold map 186 can highlight sections 188 that represent defects or deviations, while filtering out noise. The sections 188 can be compared to areas 190 of interest on images 192 of defective products, such as the products 126 shown in FIG. 1, for visual quality assessments. The merged difference map 180, the threshold map 186 and/or the images 192 can be shown as output 194 shown in FIG. 2.

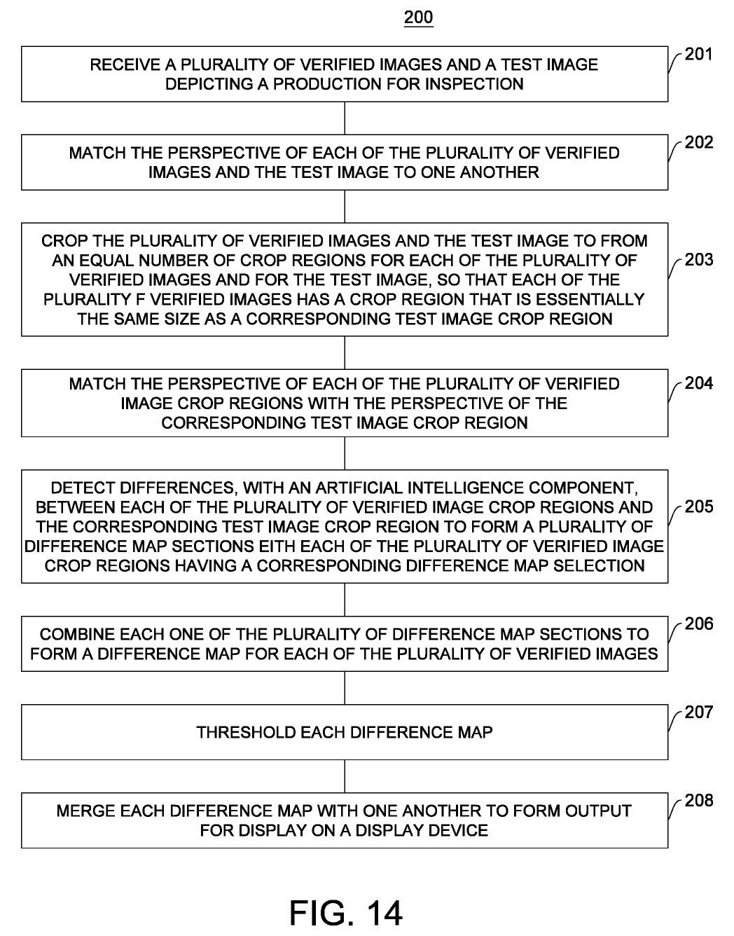

Referring to FIG. 14 with continuing reference to the foregoing figures, an exemplary process, generally designated by the numeral 200, for performing a visual quality assessment of objects is shown. The process 200 can be a performed within by system 110 within the operating environment shown in FIG. 1.

At 201, a plurality of verified images and a test image depicting a product for inspection is received. In this exemplary embodiment, the test image is obtained by the camera 112 shown in FIG. 1. The camera 112 sends the test image to the computing device 114, which can send the test image to the server 116 via the network 118.

The verified images can also be obtained by the camera 112 shown in FIG. 1. Alternatively, the verified images can be obtained offline from another source, which can be sent to the computing device 114 and/or the server 116 as needed.

At 202, the perspective of each of the plurality of verified images and the test image is matched to one another. In this exemplary embodiment, the perspective matching of images is shown in FIG. 3.

At 203, the plurality of verified images and the test image are cropped to form an equal number of crop regions for each of the plurality of verified images and for the test image, so that each of the plurality of verified images has a crop region that is essentially the same size as a corresponding test image crop region. In this exemplary embodiment, the images can be the image 148 shown in FIG. 5. The crop regions can be the crop regions 150 shown in FIG. 5.

At 204, the perspective of each of the plurality of verified image crop regions is matched with the perspective of the corresponding test image crop region. In this exemplary embodiment, the perspective matching operation is shown in FIG. 6.

At 205, differences are detected between each of the plurality of verified image crop regions and the corresponding test image crop region with an artificial intelligence component to form a plurality of difference map sections with each of the plurality of verified image crop regions having a corresponding difference map section. In this exemplary embodiment, the detection of differences is illustrated on the overlays 162 shown in FIG. 8.

At 206, each one of the plurality of difference map sections is combined to form a difference map for each of plurality of verified images. In this exemplary embodiment, the difference map can be the difference map 170 shown in FIG. 9.

At 207, each difference map is subject to a thresholding operation. In this exemplary embodiment, the results of the thresholding operation is shown as the threshold map 186 in FIG. 12.

At 208, each difference map is merged with one another to form output for display on a display device. In this exemplary embodiment, the merger of the difference maps 172-178 is shown in FIG. 10.

### Exemplary Artificial Intelligence/Machine Learning Systems

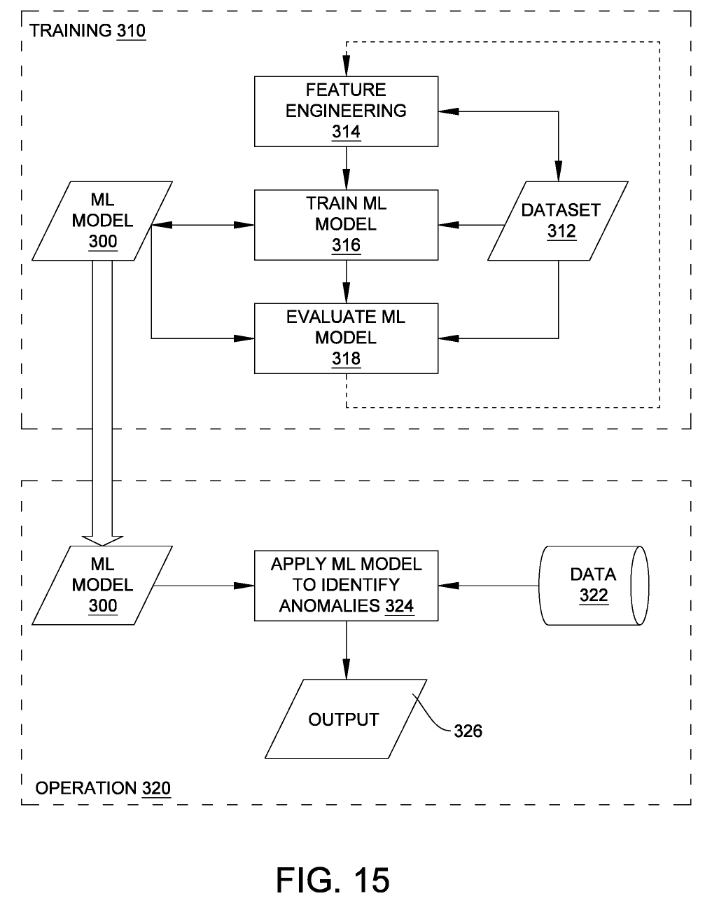

Referring now to FIG. 15 with continuing reference to the forgoing figures, an artificial intelligence/machine learning system for performing visual quality assessments is shown. The system can utilize one or more machine-learning models or other artificial intelligence (AI) functions to facilitate one or more aspects of identifying defects and/or deviations in small lots of products.

FIG. 15 illustrates a high-level diagram of machine learning, according to an embodiment. In general, each machine-learning model 300 is trained with a data sets containing images of non-anomalous objects in a training component 310 and operated to identify anomalous objects mixed within non-anomalous objects in an operation component 320. It should be understood that each machine-learning model 300 used by the application can undergo its own training component 310 and operation component 320, and that two or more machine-learning models 300 can operate independently from each other to perform different tasks or can operate in combination with each other to perform a single task.

The computing device 114 and/or the server 118, as shown in FIG. 1, can implement the training component 310 and/or the operation component 320 in this exemplary embodiment. Within training component 310, a machine-learning (ML) model 300 is trained using a dataset 312. Machine-learning model 300 can be trained using supervised or unsupervised learning. In supervised learning, dataset 312 can comprise vectors of features, with each feature vector labeled or annotated with the desired output and comprising a plurality of features that can be relevant to the determination of that output. In a case in which machine-learning model 300 is intended to identify defective objects, dataset 312 can comprise images of verified or standard objects that can be used to train the model 300, so that the operation component produces the desired recognition or classification output. In either case, dataset 312 can be cleaned and augmented in any known manner.

In subprocess 314, feature engineering functions can be used to identify the features represented within the feature vectors in dataset 312. The feature engineering functions can utilize any known manner of identifying relevant features that can correlate to an output. Features that are determined to be irrelevant can be removed from the feature vectors of dataset 312. In an alternative embodiment or embodiments which do not use feature vectors, subprocess 314 can be omitted.

In subprocess 316, machine-learning model 300 is trained using dataset 312. Specifically, machine-learning model 300 is applied to dataset 312 (e.g., which can be divided into training and validation datasets) and updates its internal structure to minimize the error between the desired output, represented by the labels in dataset 312, and its actual output.

Machine-learning model 300 can comprise any type of machine-learning algorithm, including, without limitation, an artificial neural network (e.g., a convolutional neural network, a deep neural network, etc.), a linear regression, a logistic regression, a decision tree, a random forest algorithm, a support vector machine (SVM), a naïve Bayesian classifier, a k-Nearest Neighbors (kNN) algorithm, a K-Means algorithm, gradient boosting algorithms (e.g., XGBoost, LightGBM, CatBoost), and the like. It should be understood that the particular machine-learning algorithm that is used will depend on the problem being solved, and that different machine-learning algorithms can be used within the operating environment 100 shown in FIG. 1 for different tasks.

In subprocess 318, machine-learning model 300 can be evaluated to determine its accuracy in performing the task for which it was designed. If the accuracy is not

sufficient, the training component 310 can continue. For example, a different set of features may be used for training, a different dataset 312 can be used for training, a different machine-learning algorithm can be used, and/or the like, until the evaluation in subprocess 318 demonstrates that machine-learning model 300 is suitably accurate. It should be understood that the necessary accuracy can depend on the types of defects for which machine-learning model 300 was designed to detect. For example, a machine-learning model 300 used for identifying defects or deviations of structures for certain types of high-grade PCBs can require more accuracy than a machine-learning model 300 used for identifying defects in less-critical manufacturing applications.

Once machine-learning model 300 has been trained to a sufficient accuracy, machine-learning model 300 can be moved to operation component 320 to identify defects within data 322 in a production application within the operating environment 100 shown in FIG. 1. Data 322 can comprise feature vectors derived from any of the data discussed herein and/or image data derived from any of the media discussed herein (e.g., video, etc.). In subprocess 324, machine-learning model 300 is applied to data 322 to produce output 326. Output 326 can comprise a classification (e.g., a single most likely classification, a probability vector comprising confidences for each of a plurality of possible classifications, etc.), a recommendation (e.g., recommended next action), and/or the like.

As an example, a machine-learning or other artificial-intelligence model can be trained or programmed to automatically identify defective structures or deviations on PCBs.

### Exemplary Cloud Computing Environment

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can

include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created

using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Exemplary cloud systems can be provided by AWS (Amazon Web Services) of Amazon.com, Inc. of Seattle, Washington. Other exemplary cloud systems include Azure, Google Cloud, local storage, and other equivalent systems. Azure is provided by Microsoft Corporation of Redmond, Washington. Google Cloud is provided by Google LLC of Mountain View, California.

An exemplary cloud-native system is Kubernetes (k8s), which is an open-source container orchestration system for automating software deployment, scaling, and management. The system was designed by Google, originally, The system is now maintained by a worldwide community of contributors, and the trademark is held by the Cloud Native Computing Foundation.

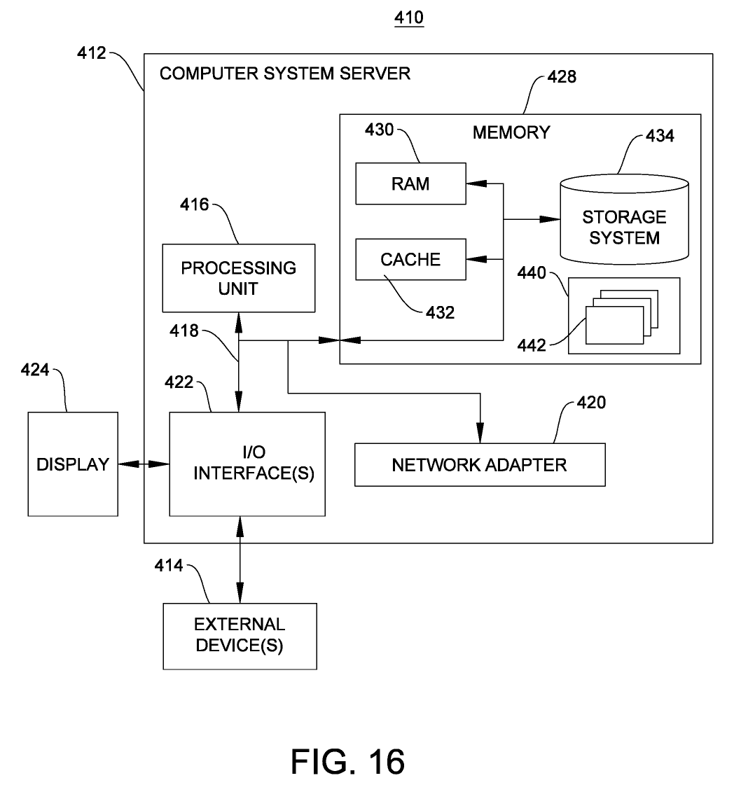

Referring now to FIG. 16, a schematic of an example of a cloud computing node is shown. Cloud computing node 410 is only one example of a suitable cloud computing node and is not intended to suggest any limitation as to the scope of use or functionality of embodiments of the invention described herein. Regardless, cloud computing node 410 is capable of being implemented and/or performing any of the functionality set forth hereinabove.

In cloud computing node 410 there is a computer system/server 412, which is operational with numerous other general purpose or special purpose computing system environments or configurations. Examples of well-known computing systems, environments, and/or configurations that can be suitable for use with computer system/server 412 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 412 can be described in the general context of computer system-executable instructions, such as program modules, being executed by a computer system. Computer system/server 412 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 16, computer system/server 412 in cloud computing node 410 is shown in the form of a general-purpose computing device. The components of computer system/server 412 can include, but are not limited to, one or more processors or processing units 416, a system memory 428, and a bus 418 that couples various system components including system memory 428 to processor 416.

Bus 418 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 412 typically includes a variety of computer system readable media. Such media can be any available media that is accessible by computer system/server 412, and it includes both volatile and non-volatile media, removable and non-removable media.

System memory 428 can include computer system readable media in the form of volatile memory, such as random access memory (RAM) 430 and/or cache memory 432. Computer system/server 412 can further include other removable/non-removable, volatile/non-volatile computer system storage media. By way of example only, storage system 434 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 418 by one or more data media interfaces. As will be further depicted and described below, memory 428 can include at least one program product having a set (e.g., at least one) of program modules that are configured to carry out the functions of embodiments of the invention.

Program/utility 440, having a set (at least one) of program modules 442, can be stored in memory 428 by way of example, and not limitation, as well as an operating system, one or more application programs, other program modules, and program data. Each of the operating system, one or more application programs, other program modules, and program data or some combination thereof, can include an implementation of a networking environment. Program modules 442 generally carry out the functions and/or methodologies of embodiments of the invention as described herein.

Computer system/server 412 can also communicate with one or more external devices 414 such as a keyboard, a pointing device, a display 424, etc.; one or more devices that enable a user to interact with computer system/server 412; and/or any devices (e.g.,

network card, modem, etc.) that enable computer system/server 412 to communicate with one or more other computing devices. Such communication can occur via Input/Output (I/O) interfaces 422. Still yet, computer system/server 412 can communicate with one or more networks such as a local area network (LAN), a general wide area network (WAN), and/or a public network (e.g., the Internet) via network adapter 420. As depicted, network adapter 420 communicates with the other components of computer system/server 412 via bus 418. It should be understood that although not shown, other hardware and/or software components could be used in conjunction with computer system/server 412. Examples, include, but are not limited to: microcode, device drivers, redundant processing units, external disk drive arrays, RAID systems, tape drives, and data archival storage systems, etc.

### Exemplary Computing Devices

Any suitable computing device or group of computing devices can be used for performing the operations described herein. For example, FIG. 1 depicts an example of the computing devices 114 and 120. Server 116 can include one or more computing devices.

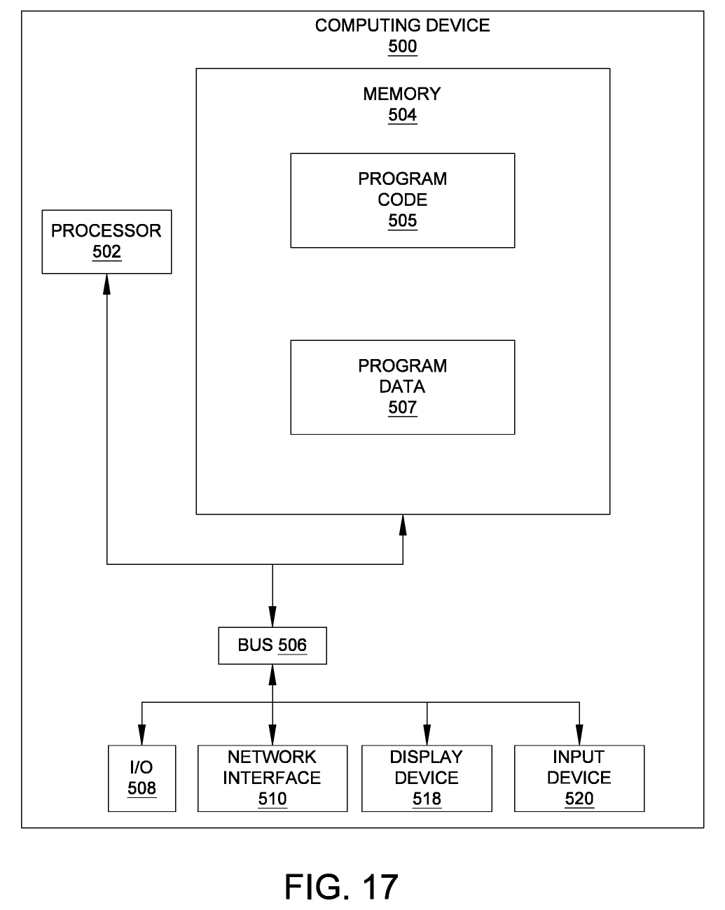

FIG. 17 depicts an example of a computing device 500 that includes a processor 502 communicatively coupled to one or more memory devices 504. The processor 502 executes computer-executable program code stored in a memory device 504, accesses information stored in the memory device 504, or both. Examples of the processor 502 include a microprocessor, an application-specific integrated circuit (“ASIC”), a field-programmable gate array (“FPGA”), or any other suitable processing device. The processor 502 can include any number of processing devices, including a single processing device.

A memory device 504 includes any suitable non-transitory computer-readable medium for storing program code 505, program data 507, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions can include processor-specific instructions generated by a compiler or an interpreter from code written in any suitable computer-programming language, including, for example, C, C++, C#, Visual Basic, Java, Python, Perl, JavaScript, Go, and ActionScript.

In some embodiments, one or more memory devices 504 stores program data 507 that includes one or more datasets and models described herein. Examples of these datasets include interaction data, performance data, etc. In some embodiments, one or more of data sets, models, and functions are stored in the same memory device (e.g., one of the memory devices 504). In additional or alternative embodiments, one or more of the programs, data sets, models, and functions described herein are stored in different memory devices 504 accessible via a data network. One or more buses 506 are also included in the computing device 500. The buses 506 communicatively couples one or more components of a respective one of the computing devices 500.

In some embodiments, the computing device 500 also includes a network interface device 510. The network interface device 510 includes any device or group of devices suitable for establishing a wired or wireless data connection to one or more data networks. Non-limiting examples of the network interface device 510 include an Ethernet network adapter, a modem, and/or the like. The computing device 500 is able to communicate with one or more other computing devices (e.g., a computing device executing a knowledge graph generation device 102) via a data network using the network interface device 510.

The computing device 500 can also include a number of external or internal devices, an input device 520, a presentation device 518, or other input or output devices. For example, the computing device 500 is shown with one or more input/output (“I/O”) interfaces 508. An I/O interface 508 can receive input from input devices or provide output to output devices. An input device 520 can include any device or group of devices suitable for receiving visual, auditory, or other suitable input that controls or affects the operations of the processor 502. Non-limiting examples of the input device 520 include a touchscreen, a mouse, a keyboard, a microphone, a separate mobile computing device, etc. A presentation device 518 can include any device or group of devices suitable for providing visual, auditory, or other suitable sensory output. Non-limiting examples of the presentation device 518 include a touchscreen, a monitor, a speaker, a separate mobile computing device, etc.

### General Considerations

Numerous specific details are set forth herein to provide a thorough understanding of the claimed subject matter. However, those skilled in the art will understand that the claimed subject matter can be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages can be used to implement the teachings contained herein in software to be used in programming or configuring a computing device.

Embodiments of the methods disclosed herein can be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as an open and inclusive language that does not foreclose devices adapted to or configured to perform additional tasks or steps. Additionally, the use of “based on” is meant to be open and inclusive, in that a process, step, calculation, or other action “based on” one or more recited conditions or values can, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

Any element in a claim that does not explicitly state “means for” performing a specified function, or “step for” performing a specified function, is not to be interpreted as a “means” or “step” clause as specified in 35 U.S.C. § 112(f). In particular, any use of “step of” in the claims is not intended to invoke the provision of 35 U.S.C. § 112(f).

### Supported Features and Embodiments

The detailed description provided above in connection with the appended drawings explicitly describes and supports various features of a visual quality assessment system. By way of illustration and not limitation, supported embodiments include a visual quality assessment system comprising: one or more processors; and at least one memory coupled to the one or more processors and storing instructions that, when executed by the one or more processors, cause the system to perform operations comprising: receiving a plurality of verified images and a test image depicting a product for inspection; matching the perspective of each of the plurality of verified images and the test image to one another; cropping the plurality of verified images and the test image to form an equal number of crop regions for each of the plurality of verified images and for the test image, so that each of the plurality of verified images has a crop region that is essentially the same size as a corresponding test image crop region; matching the perspective of each of the plurality of verified image crop regions with the perspective of the corresponding test image crop region; detecting differences, with an artificial intelligence component, between each of the plurality of verified image crop regions and the corresponding test image crop region to form a plurality of difference map sections with each of the plurality of verified image crop regions having a corresponding difference map section; combining each one of the plurality of difference map sections to form a difference map for each of plurality of verified images; thresholding each difference map; and merging each difference map with one another to form output for display on a display device.

Supported embodiments include the foregoing system, wherein the artificial intelligence component is a neural network.

Supported embodiments include any of the foregoing systems, wherein the neural network utilizes a foundational transformer to detect differences between each of the plurality of verified image crop regions and the corresponding test image crop region.

Supported embodiments include any of the foregoing systems, wherein the difference map is an attention map.

Supported embodiments include any of the foregoing systems, wherein the perspective of each of the plurality of verified image crop regions is matched with the perspective of the corresponding test image crop region using image rectification.

Supported embodiments include any of the foregoing systems, further comprising: setting a threshold to identify defective regions on each difference map.

Supported embodiments include any of the foregoing systems, further comprising: receiving input to adjust the threshold; and adjusting the threshold in response to the input.

Supported embodiments include a computer-implemented method for quality assessment, the method comprising: receiving a plurality of verified images and a test image depicting a product for inspection; matching the perspective of each of the plurality of verified images and the test image to one another; cropping the plurality of verified images and the test image to form an equal number of crop regions for each of the plurality of verified images and for the test image, so that each of the plurality of verified images has a crop region that is essentially the same size as a corresponding test image crop region; matching the perspective of each of the plurality of verified image crop regions with the perspective of the corresponding test image crop region; detecting differences, with an artificial intelligence component, between each of the plurality of verified image crop regions and the corresponding test image crop region to form a plurality of difference map sections with each of the plurality of verified image crop regions having a corresponding difference map section; combining each one of the plurality of difference map sections to form a difference map for each of plurality of verified images; thresholding each difference map; and merging each difference map with one another to form output for display on a display device.

Supported embodiments include the foregoing method, wherein the artificial intelligence component is a neural network.

Supported embodiments include any of the foregoing methods, wherein the neural network utilizes a foundational transformer to detect differences between each of the plurality of verified image crop regions and the corresponding test image crop region.

Supported embodiments include any of the foregoing methods, wherein the difference map is an attention map.

Supported embodiments include any of the foregoing methods, wherein the perspective of each of the plurality of verified image crop regions is matched with the perspective of the corresponding test image crop region using image rectification.

Supported embodiments include any of the foregoing methods, further comprising: setting a threshold to identify defective regions on each difference map.

Supported embodiments include any of the foregoing methods, further comprising: receiving input to adjust the threshold; and adjusting the threshold in response to the input.

Supported embodiments include a system, comprising: a video camera; a computing device coupled to the video camera; a server coupled to the computing device over a network; and a display device coupled to the server over the network; wherein the video camera captures a plurality of verified images and a test image depicting a product for inspection and sends the plurality of verified images and the test image to the server via the computing device; wherein the server matches the perspective of each of the plurality of verified images and the test image to one another; wherein the server crops the plurality of verified images and the test image to form an equal number of crop regions for each of the plurality of verified images and for the test image, so that each of the plurality of verified images has a crop region that is essentially the same size as a corresponding test image crop region; wherein the server matches the perspective of each of the plurality of verified image crop regions with the perspective of the corresponding test image crop region; wherein the server detects differences, with an artificial intelligence component, between each of the plurality of verified image crop regions and the corresponding test image crop region to form a plurality of attention map sections with each of the plurality of verified image crop regions having a corresponding attention map section; wherein the server combines each one of the plurality of attention map sections to form a attention map for each of plurality of verified images; wherein the server thresholds each attention map; and wherein the server merges each attention map with one another to form output for display on the display device.

Supported embodiments include the foregoing system, wherein the artificial intelligence component is a neural network.

Supported embodiments include any of the foregoing systems, wherein the neural network utilizes a foundational transformer to detect differences between each of the plurality of verified image crop regions and the corresponding test image crop region.

Supported embodiments include any of the foregoing systems, wherein the perspective of each of the plurality of verified image crop regions is matched with the perspective of the corresponding test image crop region using image rectification.

Supported embodiments include any of the foregoing systems, further comprising: setting a threshold to identify defective regions on each attention map.

Supported embodiments include any of the foregoing systems, further comprising: receiving input to adjust the threshold; and adjusting the threshold in response to the input.

Supported embodiments include a device, an apparatus, a computer-readable storage medium, a computer program product and/or means for implementing any of the foregoing systems, methods, or portions thereof.

The detailed description provided above in connection with the appended drawings is intended as a description of examples and is not intended to represent the only forms in which the present examples can be constructed or utilized.

It is to be understood that the configurations and/or approaches described herein are exemplary in nature, and that the described embodiments, implementations and/or examples are not to be considered in a limiting sense, because numerous variations are possible.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed.

Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A visual quality assessment system comprising: one or more processors; and at least one memory coupled to the one or more processors and storing instructions that, when executed by the one or more processors, cause the system to perform operations comprising: receiving a plurality of verified images and a test image depicting a product for inspection; matching the perspective of each of the plurality of verified images and the test image to one another; cropping the plurality of verified images and the test image to form an equal number of crop regions for each of the plurality of verified images and for the test image, so that each of the plurality of verified images has a crop region that is essentially the same size as a corresponding test image crop region; matching the perspective of each of the plurality of verified image crop regions with the perspective of the corresponding test image crop region; detecting differences, with an artificial intelligence component, between each of the plurality of verified image crop regions and the corresponding test image crop region to form a plurality of difference map sections with each of the plurality of verified image crop regions having a corresponding difference map section; combining each one of the plurality of difference map sections to form a difference map for each of plurality of verified images; thresholding each difference map; and merging each difference map with one another to form output for display on a display device.

2. The system of claim 1, wherein the artificial intelligence component is a neural network.

3. The system of claim 2, wherein the neural network utilizes a foundational transformer to detect differences between each of the plurality of verified image crop regions and the corresponding test image crop region.

4. The system of claim 2, wherein the difference map is an attention map.

5. The system of claim 1, wherein the perspective of each of the plurality of verified image crop regions is matched with the perspective of the corresponding test image crop region using image rectification.

6. The system of claim 1, further comprising: setting a threshold to identify defective regions on each difference map.

7. The system of claim 6, further comprising: receiving input to adjust the threshold; and adjusting the threshold in response to the input.

8. A computer-implemented method for quality assessment, the method comprising: receiving a plurality of verified images and a test image depicting a product for inspection; matching the perspective of each of the plurality of verified images and the test image to one another; cropping the plurality of verified images and the test image to form an equal number of crop regions for each of the plurality of verified images and for the test image, so that each of the plurality of verified images has a crop region that is essentially the same size as a corresponding test image crop region; matching the perspective of each of the plurality of verified image crop regions with the perspective of the corresponding test image crop region; detecting differences, with an artificial intelligence component, between each of the plurality of verified image crop regions and the corresponding test image crop region to form a plurality of difference map sections with each of the plurality of verified image crop regions having a corresponding difference map section; combining each one of the plurality of difference map sections to form a difference map for each of plurality of verified images; thresholding each difference map; and merging each difference map with one another to form output for display on a display device.

9. The method of claim 8, wherein the artificial intelligence component is a neural network.

10. The method of claim 9, wherein the neural network utilizes a foundational transformer to detect differences between each of the plurality of verified image crop regions and the corresponding test image crop region.

11. The method of claim 9, wherein the difference map is an attention map.

12. The method of claim 8, wherein the perspective of each of the plurality of verified image crop regions is matched with the perspective of the corresponding test image crop region using image rectification.

13. The system of claim 1, further comprising: setting a threshold to identify defective regions on each difference map.

14. The system of claim 6, further comprising: receiving input to adjust the threshold; and adjusting the threshold in response to the input.

15. A system, comprising: a video camera; a computing device coupled to the video camera; a server coupled to the computing device over a network; and a display device coupled to the server over the network; wherein the video camera captures a plurality of verified images and a test image depicting a product for inspection and sends the plurality of verified images and the test image to the server via the computing device; wherein the server matches the perspective of each of the plurality of verified images and the test image to one another; wherein the server crops the plurality of verified images and the test image to form an equal number of crop regions for each of the plurality of verified images and for the test image, so that each of the plurality of verified images has a crop region that is essentially the same size as a corresponding test image crop region; wherein the server matches the perspective of each of the plurality of verified image crop regions with the perspective of the corresponding test image crop region; wherein the server detects differences, with an artificial intelligence component, between each of the plurality of verified image crop regions and the corresponding test image crop region to form a plurality of attention map sections with each of the plurality of verified image crop regions having a corresponding attention map section; wherein the server combines each one of the plurality of attention map sections to form a attention map for each of plurality of verified images; wherein the server thresholds each attention map; and wherein the server merges each attention map with one another to form output for display on the display device.

16. The system of claim 15, wherein the artificial intelligence component is a neural network.

17. The system of claim 16, wherein the neural network utilizes a foundational transformer to detect differences between each of the plurality of verified image crop regions and the corresponding test image crop region.

18. The system of claim 15, wherein the perspective of each of the plurality of verified image crop regions is matched with the perspective of the corresponding test image crop region using image rectification.

19. The system of claim 15, further comprising: setting a threshold to identify defective regions on each attention map.

20. The system of claim 19, further comprising: receiving input to adjust the threshold; and adjusting the threshold in response to the input.
